(19) United States
(12) Patent Application Publication
(10) Pub. No.: US 2010/0159424 A1
(43) Pub. Date: Jun. 24, 2010

(54) CEREAL BOX SLEEVE

(76) Inventor: Moshe Kugel, Brooklyn, NY (US)

Correspondence Address: David Klein;DEKEL PATENT LTD., Beit HaRof' im, 18 Menuha VeNahala Street, Room 27, Rehovot, IL

(21) Appl. No.: 12/719,959

(22) Filed: Mar. 9, 2010

Related U.S. Application Data
(63) Continuation-in-part of application No. 11/829,955, filed on Jul. 30, 2007.

(51) Int. Cl. G09B 29/00; B65D 5/62; G09B 19/00; G09B 1/00; G09B 25/00

(52) U.S. Cl. 434/150; 229/164.1; 434/154; 434/167; 434/209; 434/365

(57) ABSTRACT

An article including a series of different cereal box sleeves dimensioned to fit over a cereal box, each of the sleeves including content printed or otherwise formed thereon, wherein the content is a subject unrelated to cereal contained in the cereal box, wherein a common theme connects the content of the sleeves in the series of the sleeves.

### CROSS-REFERENCE TO RELATED APPLICATIONS

This application is a continuation-in-part of, and claims priority under 35 USC §120 from, U.S. patent application Ser. No. 11/829,955, filed Jul. 30, 2007, which is incorporated herein by reference.

### FIELD OF THE INVENTION

The present invention relates generally to cereal boxes, and particularly to a sleeve that may be placed over a cereal box for advertising, educational or entertainment purposes and such.

### BACKGROUND OF THE INVENTION

Due to the fierce competition in the marketing of breakfast cereals, it is the practice of many cereal manufacturers to include a premium, prize or toy and such with the cereal to promote the sale of the cereal beyond the marketability of the cereal itself. Another well known practice is to print on the back panel of the cereal box various items to promote sales, such as cut-out cards, games or other associated paraphernalia which are desired by children or adults.

### SUMMARY OF THE INVENTION

The present invention seeks to provide a novel sleeve that may be placed over a cereal box for advertising, educational or entertainment purposes and such, as is described further in detail hereinbelow.

There is thus provided in accordance with an embodiment of the present invention an article including a series of different cereal box sleeves dimensioned to fit over a cereal box, each of the sleeves including content printed or otherwise formed thereon, wherein the content is a subject unrelated to cereal contained in the cereal box, wherein a common theme connects the content of the sleeves in the series of the sleeves.

The cereal box sleeve may be open-ended, having four closed sides with open ends at top and bottom ends thereof. Alternatively, the cereal box sleeve may be a lid-less and tab-less overlay movably mountable on the cereal box. The cereal box sleeve may be washable and disposable.

The subject can be an educational subject (e.g., geography, arithmetic, history, vocabulary, biographies, multiplication table, map and many more).

There is also provided in accordance with an embodiment of the present invention a combination of a cereal box and a cereal box sleeve fit over the cereal box.

There is also provided in accordance with an embodiment of the present invention a method including using cereal-eating time for education by movably mounting a cereal box sleeve on a cereal box, the cereal box sleeve including content printed or otherwise formed thereon, wherein the content is an educational subject unrelated to cereal contained in the cereal box, and reading the educational subject on the cereal box sleeve.

### BRIEF DESCRIPTION OF THE DRAWINGS

The present invention will be understood and appreciated more fully from the following detailed description, taken in conjunction with the drawings in which:

FIGS. 1 and 2 are simplified illustrations of a cereal box sleeve, constructed and operative in accordance with an embodiment of the present invention, respectively before and after placing on a cereal box.

### DETAILED DESCRIPTION OF EMBODIMENTS

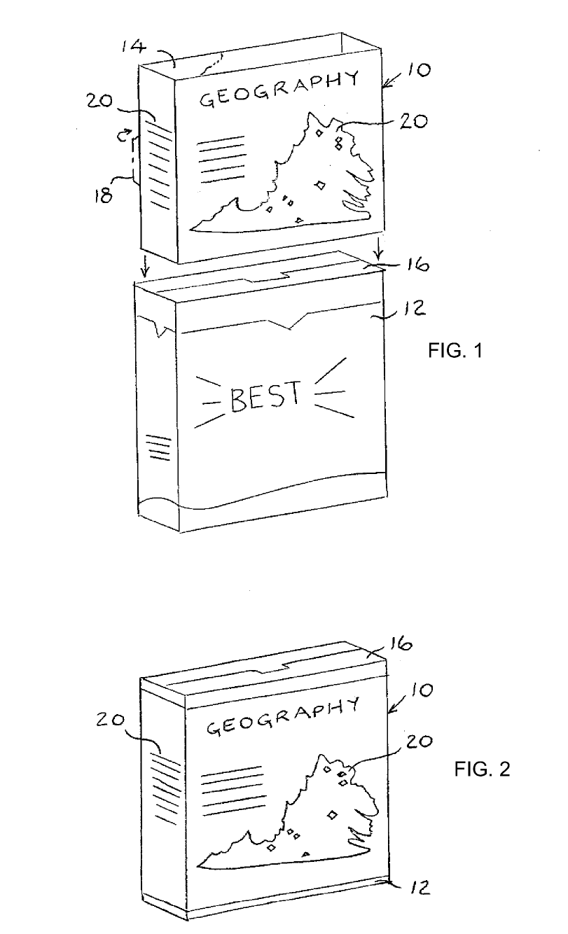

Reference is now made to FIGS. 1 and 2, which illustrate a cereal box sleeve 10, constructed and operative in accordance with an embodiment of the present invention.

Cereal box sleeve 10 is dimensioned to fit over a cereal box 12. Cereal box sleeve 10 may be open-ended, that is, it may have four closed sides with open ends at the top and bottom. In such an embodiment, cereal box sleeve 10 is designed to be placed loosely or snugly over the cereal box 12.

The term “sleeve” throughout the specification and claims encompasses any kind of covering, such as but not limited to, a sleeve, cover, jacket, overlay, wrap and the like, and the terms are used interchangeably throughout.

In another embodiment, cereal box sleeve 10 may have a closed top side 14 (shown partially in broken lines in FIG. 1) so that when sleeve 10 is placed over box 12 the top end covers top flaps 16 of box 12. Alternatively, the bottom side may be closed.

In yet another embodiment, cereal box sleeve 10 may include a wrap-around sleeve that is initially flat and is wrapped around the cereal box 12 and closed with a fastener 18 (shown partially in broken lines in FIG. 1—it gets fastened to the back side of sleeve 10 as indicated by the curved arrow), such as but not limited to, tuck-in flaps, VELCRO fastener, loop fastener, sticky adhesive fastener and the like. Cereal box sleeve 10 may include a single sheet which is attached to the cereal box by a sticky adhesive fastener and the like. In such an embodiment, cereal box sleeve 10 is an overlay which is lid-less and tab-less at top and bottom ends thereof

Cereal box sleeve 10 may be fashioned of paper, plastic film, foil (plastic or metal) or any other suitable material. Cereal box sleeve 10 may be washable for re-use or it may be disposable. Cereal box sleeve 10 may be transparent, translucent or opaque, and may be of any shape, size and color.

Cereal box sleeve 10 preferably has content 20 printed or otherwise formed thereon, wherein the content is a subject unrelated to cereal contained in the cereal box. The content 20 may be educational content, such as but not limited to, multiplication tables, ABCs, maps etc. The few minutes of breakfast time are a good educational opportunity for children to learn subjects, such as but not limited to, geography, arithmetic, history, vocabulary, biographies, etc. Additionally or alternatively, the content 20 may include advertising or entertainment content. Content 20 may be pictures or words or combinations thereof, and may be printed or otherwise formed on one or more sides of cereal box sleeve 10.

In accordance with an embodiment of the present invention, a series of different cereal box sleeves are provided that are a series of educational or entertainment content. For example, the sleeves could show maps of the 50 states, or of countries or rivers of the world. As another example, the sleeves could show a series of arithmetic or algebra lessons; history lessons (e.g., series of Civil War battles); biographies (e.g., presidents of the United States); cartoon strips and much more. A common theme connects the content of the sleeves in each series of the sleeves.

The scope of the present invention includes both combinations and subcombinations of the features described hereinabove as well as modifications and variations thereof which would occur to a person of skill in the art upon reading the foregoing description and which are not in the prior art.

What is claimed is:

1. An article comprising:
a series of different cereal box sleeves dimensioned to fit over a cereal box, each of said sleeves comprising content printed or otherwise formed thereon, wherein said content is a subject unrelated to cereal contained in said cereal box, wherein a common theme connects the content of the sleeves in the series of the sleeves.

2. The article according to claim 1, wherein each of said cereal box sleeves is open-ended, having four closed sides with open ends at top and bottom ends thereof.

3. The article according to claim 1, wherein each of said cereal box sleeves is a lid-less and tab-less overlay movably mountable on said cereal box.

4. The article according to claim 1, wherein each of said cereal box sleeves is washable.

5. The article according to claim 1, wherein each of said cereal box sleeves is disposable.

6. The article according to claim 1, wherein said subject is an educational subject.

7. The article according to claim 6, wherein said educational subject is geography.

8. The article according to claim 6, wherein said educational subject is arithmetic.

9. The article according to claim 6, wherein said educational subject is history.

10. The article according to claim 6, wherein said educational subject is vocabulary.

11. The article according to claim 6, wherein said educational subject is biographies.

12. The article according to claim 6, wherein said educational subject is a multiplication table.

13. The article according to claim 6, wherein said educational subject is a map.

14. An article comprising:
a cereal box; and
a series of different cereal box sleeves dimensioned to fit over the cereal box, each of said sleeves comprising content printed or otherwise formed thereon, wherein said content is a subject unrelated to cereal contained in said cereal box, wherein a common theme connects the content of the sleeves in the series of the sleeves.

15. A method comprising:
using cereal-eating time for education by movably mounting a cereal box sleeve on a cereal box, said cereal box sleeve comprising content printed or otherwise formed thereon, wherein said content is an educational subject unrelated to cereal contained in said cereal box, and reading the educational subject on the cereal box sleeve.

16. The method according to claim 15, wherein the cereal box sleeve is one of a series of different cereal box sleeves dimensioned to fit over the cereal box, wherein a common theme connects the content of the sleeves in the series of the sleeves.
